(19) United States
(12) Patent Application Publication
(10) Pub. No.: US 2003/0154207 A1
(43) Pub. Date: Aug. 14, 2003

(54) Information processing system

(76) Inventor: Atsushi Naito, Nara (JP)

Correspondence Address: NIXON & VANDERHYE, PC, 1100 N GLEBE ROAD, 8TH FLOOR, ARLINGTON, VA, 22201-4714, US

(21) Appl. No.: 10/361,750

(22) Filed: Feb. 11, 2003

(30) Foreign Application Priority Data
Feb. 14, 2002 (JP) 37189/2002

(51) Int. Cl. G06F 7/00

(52) U.S. Cl. 707/100

(57) ABSTRACT

Data entry on an information device is facilitated by an information processing system comprising an information device equipped with a display unit and an input unit. The information processing system further comprises a control unit for coordinating the operation of a first application running on the information device and that of a second to nth (n=an integer of more than 2) applications that are relevant to the first application and running on the information device. The control unit has an application menu display function for displaying an application menu on the display unit upon selection of specific data by the input unit from data displayed on the display unit in the first application, the menu showing the name of at least one application selected from the second to nth applications.

### BACKGROUND OF THE INVENTION

1. Technical Field

The present invention relates to an information processing system in which a plurality of applications can be coordinated and, in particular, share data among them. Particularly, the invention relates to an information processing system capable of utilizing specific information, such as one obtained from electronic mail data, in a relevant application in a versatile manner.

2. Background Art

Recent developments in electronic mail systems now allow people to exchange email by using small-sized information processing devices such as personal computers and personal digital assistants (PDA), and even cell phones.

The PDAs and cell phones (to be hereafter referred to as portable information devices) are required to be small enough to fit into a shirt pocket for easy carry around. For this reason, a portable information device is not usually equipped with a keyboard such as the one for personal computers that allows for manual data entry. Instead, various data entry methods have been proposed for portable information devices. Examples include: attaching a touch panel on the display screen so that data can be entered manually by a stylus pen; providing a miniature keyboard for data entry via a stylus pen; and assigning both numerals and alphabets to more or less a dozen keys.

In any of the above methods, it is still more difficult to enter data on a portable information device than to do so with the conventional keyboard. Furthermore, it is becoming increasingly common to equip the portable information device with features such as a calendar, contact list, promise list, memo pad, and Internet web browser, all at once, in addition to the email capability.

Under these circumstances, more and more information is being picked up in the form of electronic information gathered via email and the Internet, rather than from paper documents.

It would be convenient, therefore, if specific data can be selected from electronic information of the above-mentioned kind and used as the source of information to be displayed in the calendar, contact list, or the like.

For example, JP Patent Publication (Unexamined Application) No. 10-301869 discloses an electronic mail apparatus in which patterns of character sequences presumably included in a received email text are associated with applications, such that when a user selects a character sequence in the email text, an application is automatically opened that is associated with that character sequence. This apparatus makes it easier to enter data or the like from received email into various applications, thus improving operation efficiency.

However, this email apparatus requires the presumed character sequence patterns to be registered in advance, so that every time a new pattern is encountered it has to be registered. Even similar patterns of the same meaning, such as Feb. 3, 2001, Mar. 2, 2001, Jan. 2, 2003 and so on for February 3 of the year 2001, have to be registered separately, which can be troublesome.

Alternatively, specific data included in an email can be selected and copied in a data storage unit on a clipboard, and then an application making use of the specific data can be opened. The specific data can then be read out of the data storage unit on the clipboard and pasted on a new document screen.

However, this method also requires many operation steps and can be troublesome.

### SUMMARY OF THE INVENTION

It is therefore an object of the invention to provide an information processing system capable of coordinating an application such as an email application with other desired applications easily.

In one aspect, the invention provides an information processing system comprising an information device equipped with a display unit and an input unit, the information processing system further comprising:

a control unit for coordinating the operation of a first application running on the information device and that of a second to nth (n=an integer of more than 2) applications that are related to the first application and running on the information device,

wherein the control unit has an application menu display function for displaying, upon selection of specific data in data displayed on the display unit in the first application by means of the input unit, an application menu on the display unit, the application menu showing the name of at least one application selected from the second to nth applications.

Preferably, the application menu is a list of the names of applications that were predicted to be relevant to the specific data based on the contents of the specific data, from which list a desired application can be opened.

In accordance with the above information processing system, the first application and the specific data that is contained in the first application and which is selected by the user can be utilized in a relevant application by a simple operation.

The application relevant to the specific data can be predicted on the basis of the attributes of the selected specific data. The utilization of the specific data includes pasting the specific data in the relevant application.

### BRIEF DESCRIPTION OF THE DRAWINGS

FIG. 1 shows a block diagram of an information device, such as a PDA, that is used in the information processing system in various embodiments of the invention.

FIG. 2 shows a block diagram of the portable information device included in the information processing system of a first embodiment of the invention, in which an email application is associated with a relevant application thereof, namely a calendar application.

FIG. 3 shows an example of the display window of the email application.

FIG. 4 shows an example of the display window in the calendar application.

FIG. 5 shows a flowchart of exemplary operations performed in the information processing system according to the first embodiment.

FIGS. 6A and 6B show concrete examples in a display window.

FIGS. 7C and 7D show other concrete examples in a display window.

FIG. 8 shows another example of the display window in the calendar application.

FIG. 9 shows a block diagram of the portable information device included in the information processing system according to another embodiment of the invention, in which the email application is associated with a relevant application thereof, namely a contact list application.

FIG. 10 shows an example of the display window in the contact list application.

FIG. 11 shows a block diagram of the portable information device included in the information processing system according to another embodiment of the invention, in which the email application is associated with a relevant application thereof, namely a promise-list application.

FIG. 12 shows an example of the display window in the promise-list application.

FIG. 13 shows a block diagram of the portable information device included in the information processing system according to another embodiment of the invention, in which the email application is associated with a relevant application thereof, namely a memo pad application.

FIG. 14 shows an example of the display window in the memo pad application.

FIG. 15 shows a block diagram of the portable information device included in the information processing system according to another embodiment of the invention, in which the email application is associated with a relevant application thereof, namely a user dictionary application.

FIG. 16 shows an example of the display window in the user dictionary application.

FIG. 17 shows a block diagram of the portable information device included in the information processing system according to another embodiment of the invention, in which two email applications are associated with one another.

FIG. 18 shows an example of a new document window in the email application of FIG. 17.

FIG. 19 shows a block diagram of the portable information device included in the information processing system according to another embodiment of the invention, in which an image processing application is associated with a relevant application thereof, namely a document application.

FIG. 20 shows an example of image data displayed in the image application.

FIG. 21 shows an example of a new document window showing document data in a new document window in a document application in which specific image data selected from the image application is attached.

### DESCRIPTION OF THE INVENTION

The term “information processing system” herein refers to a system including an information device such as a cell phone or PDA, a basic operating system (OS) for running various applications on the information device, and various application software running on the basic OS. The basic OS is stored in a non-volatile memory ROM (read-only memory), for example, in the case of a PDA. The various application software items are usually stored in a random access memory (RAM), for example, which is a high-speed memory that stores information by a power supply backed up by a button cell, for example.

The term may also include devices such as personal computers, in which the basic OS and a variety of applications are stored on a hard disc.

A control unit described herein is not limited to hardware, such as a CPU in the information device.

The control unit herein is a general term to describe hardware and/or software required for operating the system, and so the control unit may be formed only by software, depending on the structure of the information device. The control unit may therefore include software for performing necessary functions and hardware for running the software.

While in the description of various embodiments of the invention that follows, a data management unit in each application, such as an email data management unit in an email application, is described as managing application data such as email data, the management unit may include part or all of the functions of the control unit. The data management unit also includes the function as an interface between different software items.

The phrase “can be utilized in a versatile manner” herein means that data can be utilized more than once (even in different applications). It also means that data that has once been pasted can be copied and pasted again in a particular application.

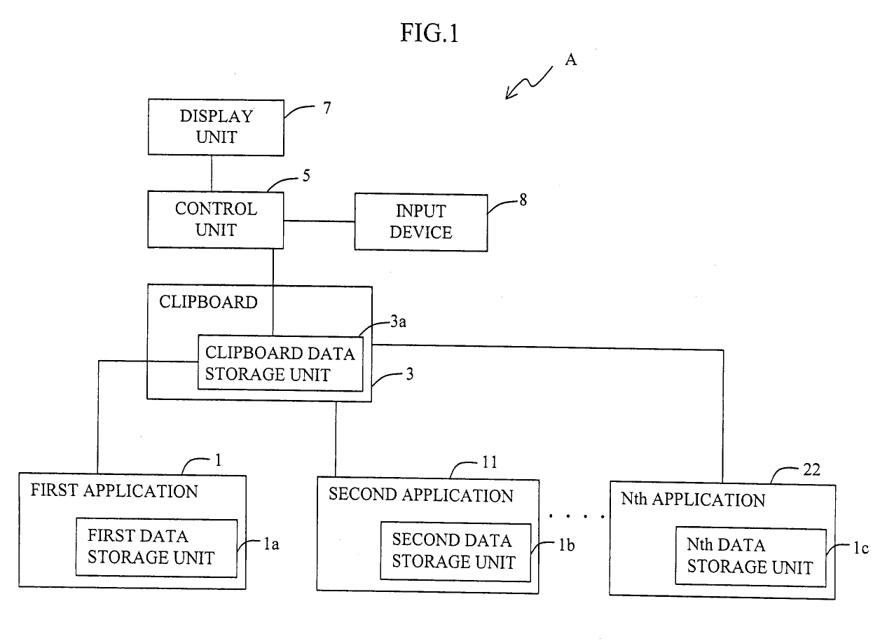

Referring to FIG. 1, the concept of the information processing system according to an embodiment of the invention will be described.

FIG. 1 shows the block diagram of an information device A, such as a PDA, that is used in an information processing system.

As shown, the information device A includes a control unit 5, a display unit 7 and an input device 8. The information device A can operate a first application 1, a second application 11, up to an nth application 22.

In this example, a first data storage unit 1a is assigned to the first application, a second data storage unit 1b is assigned to the second application 11, and an nth data storage unit 1c is assigned to the nth application 22. The information device A further includes a clipboard 3. The clipboard 3 includes a clipboard data storage unit 3a.

When the first application 1 is running on the information device A, data concerning the first application 1 is stored in the first data storage unit 1a and displayed on the display unit 7.

When specific data in the data displayed on the display unit 7 is selected by means of the input device 8, the control unit 5 analyzes the attributes of the selected specific data and predicts at least one relevant application. The control unit 5 then displays an application menu listing the names of predicted applications on the display unit 7, and stores the specific data in the clipboard storage unit 3a of the clipboard 3.

By selecting one of the predicted applications (to be referred to as relevant applications), the user can open the relevant application. The user can then make use of the specific data stored in the clipboard storage unit 3a in the relevant application. For example, the user can paste the specific data. The specific data that has been stored in the clipboard storage unit 3a can be utilized in the relevant application in a versatile manner. Namely, the data can be utilized in the same relevant application or in different relevant applications repeatedly.

Thus, the user can select a specific portion of data in the data that is displayed on the display unit in the first application and use it in a relevant application in a simple manner.

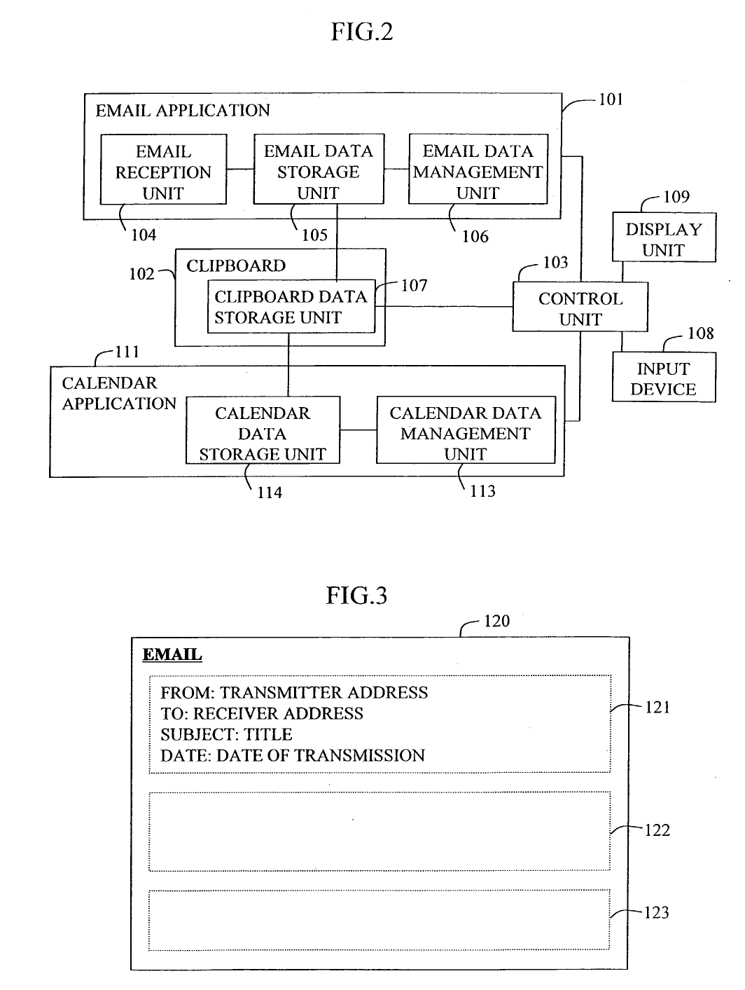

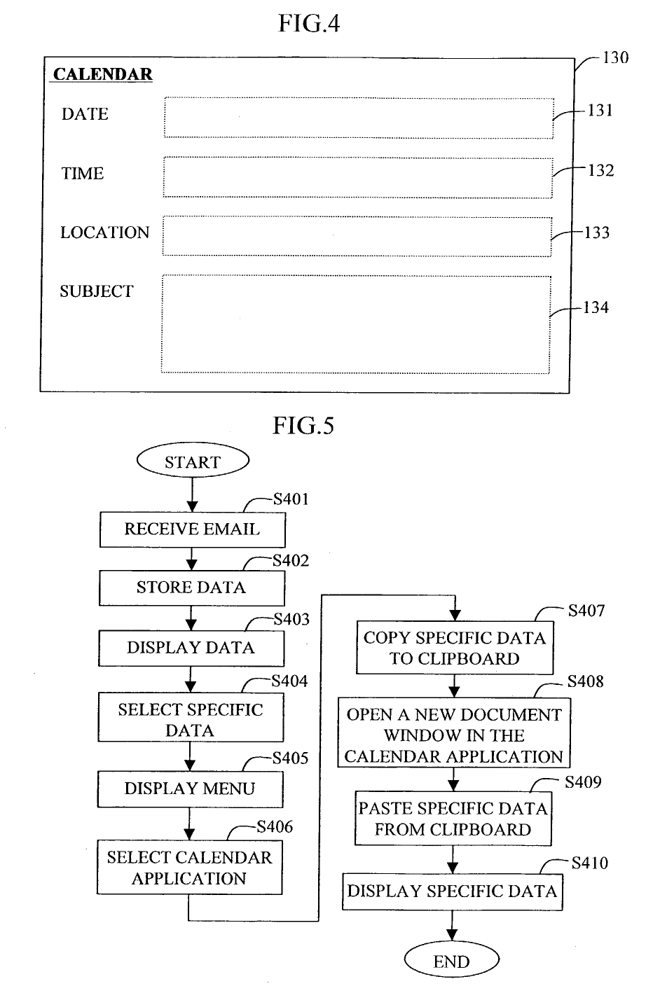

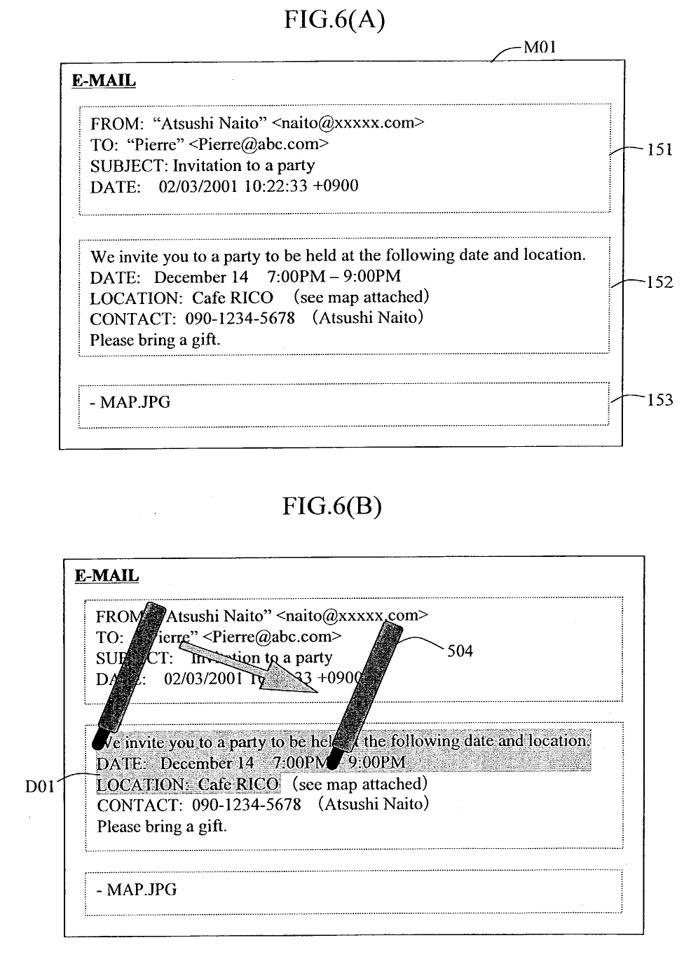

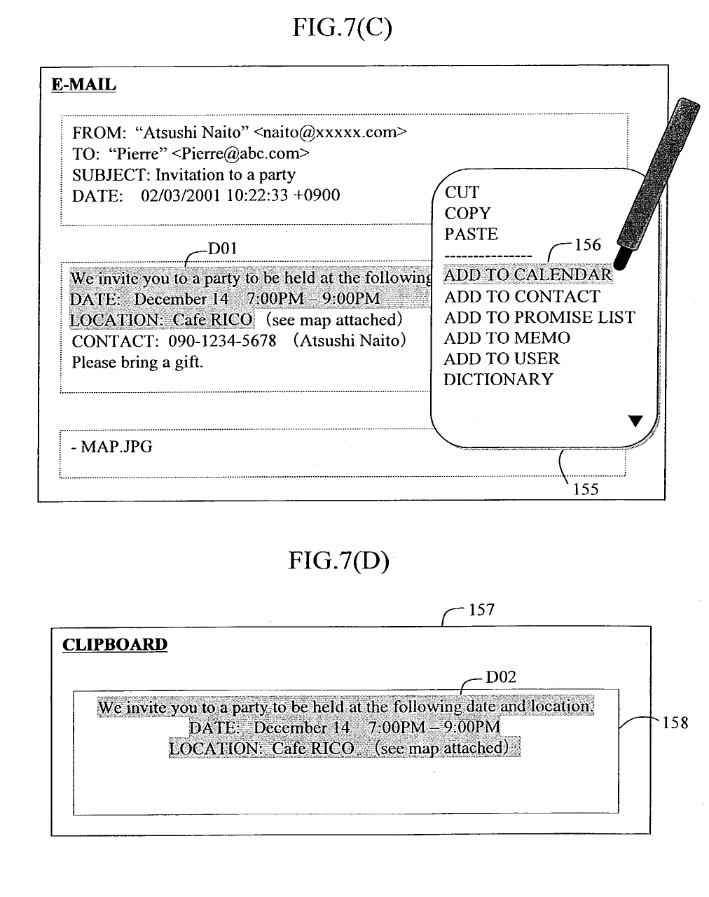

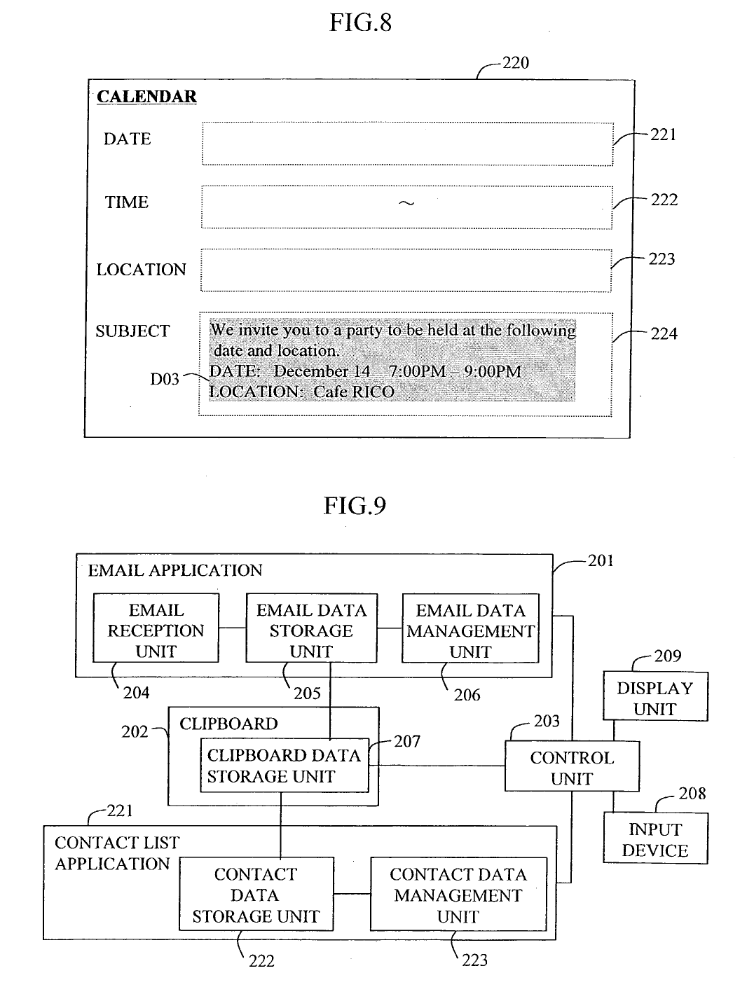

A first embodiment of the invention will be described by referring to FIGS. 2 to 8. FIG. 2 shows the block diagram of a PDA included in an information processing system according to the first embodiment. FIG. 3 shows an example of the display screen in an email application. FIG. 4 shows an example of the display screen in a calendar application. FIG. 5 shows a flowchart of the operations performed in the information processing system of the first embodiment. FIG. 6A to FIG. 7D show concrete examples of the display screen. FIG. 8 shows an example of the display screen in a calendar application.

As shown in FIG. 2, in the PDA used in the information processing system of the present embodiment, an email application 101 and a calendar application 111 can be run. The PDA includes a control unit 103 for controlling the system as a whole, a clipboard 102, an email reception unit 104 for receiving email, an input device 108 for data entry, and a display unit 109 for displaying data. The clipboard 102 temporarily stores data. The clipboard data storage unit 107 is provided in the clipboard 102 and temporarily stores data for each application.

The email application 101 further includes an email data storage unit 105 for storing email data and an email data management unit 106 for managing email data. The calendar application 111 includes a calendar data storage unit 112 for storing calendar data and a calendar data management unit 113 for managing data for the calendar application 111.

As shown in FIG. 3, email display data 120 stored in the email data storage unit 105 (FIG. 2) includes an email header field 121, an email main text field 122 and an attachment file field 123, for example.

The email header field 121 displays a sender address, receiver address, title, date of transmission, and the like. The email main text field 122 describes the data forming the main text of email in a data format such as text data or HTML. The attachment file field 123 displays files or the like attached to email data.

Referring to FIG. 4, a calendar window 130 based on the data stored in the calendar data storage unit 112 (FIG. 2) in the calendar application 111 includes a date field 131 showing the date, for example, a time field 132 showing the time, a location field 132 showing the location, and a subject field 134 showing the subject.

Now referring to the flowchart of FIG. 5, the operation procedure of the email system according to the present embodiment will be described. FIGS. 2 to 4 and FIGS. 6 to 8 will also be referred to whenever necessary.

In step S401, the email reception unit 104 receives email from the outside. Alternatively email data that has already been received may be used. In step S402, the data of the email received in step S401 is stored in the email data storage unit 105. In step S403, the email data stored in the email data storage unit 105 is managed by the email management unit 106 and displayed on the display unit 109 in response to an instruction from the control unit 103.

In step S404, the user selects specific data included in the email data by using an input device (such as a stylus pen 504). In step S405, the control unit 103, automatically responding to the selection operation, predicts relevant applications related to the specific data on the basis of the attributes of the specific data. The control unit 103 then displays a list of the predicted relevant applications (application menu) on the display unit 109. Alternatively, the selection may be followed by another predetermined operation, such as tapping the selected portion, to display the application menu. The attributes of the specific data are the properties that allow the type and/or contents of the data to be identified, e.g., whether the data is image data such as JPEG or document data such as TEXT and DOC. The attributes may also be properties that allow the identification of date/time data, name data and/or content data in document data.

In step S406, the user taps the instruction “Add to calendar” to select an application, such as the calendar application 111, for which the user desires data entry support, from the applications displayed in the application menu 155. In step S407, the control unit 103 copies the selected specific data and stores it in the data storage unit 107 of the clipboard 102.

In step S408, the control unit 103 opens a new document window in the selected calendar application 111. In step S409, the specific data stored in the data storage unit 107 of the clipboard 102 is stored in the calendar data storage unit 112 of the calendar application 111. In step S410, the calendar application 111 causes the specific data, which is now stored in the calendar data storage unit 112 and managed by the calendar data management unit 113, to be displayed on the display unit 109.

By the above-described procedure, the specific data included in the email data can be easily pasted (entered) in the data displayed in the calendar application 111 in a reduced number of operation steps.

The above procedure will be described in more detail by referring to FIG. 6A to FIG. 7D and FIG. 8. FIGS. 2 to 5 will also be referred to when necessary.

FIG. 6A shows email data M01 received by the email application 101. The received email data M01 is stored in the email data storage unit 105 and managed by the email data management unit 106. The email data M01 includes an email header field 151, an email main text field 152, and an attachment file field 153. In the illustrated example, the attachment file field 153 has an attachment of a map in JPEG format.

FIG. 6B illustrates the user selecting specific data D01, for example, by dragging a stylus pen 504 on main text data in the email main text field 152 included in the email data M01.

As shown in FIG. 7C, the control unit 103 automatically responds to the selection of the specific data D01 and displays an application selection menu 155 in the display window on the display unit 109. The application selection menu 155 shows a calendar application, contact list application, promise-list application, memo pad application and user dictionary application, for example. Other relevant applications can also be displayed by tapping the black triangle pointing downward. In the present embodiment, the calendar application is selected. Namely, the user selects the text “Add to calendar” 156 in the menu. As shown in FIG. 7D, the control unit 103 stores the thus selected specific data D01 in the data storage unit 107 of the clipboard 102 as specific data D02.

Referring to FIG. 8, new document data 220 of the calendar application 111 is displayed in accordance with the selected instruction “Add to calendar” 156. The specific data D02 stored in the data storage unit 107 of the clipboard 102 is then stored in the calendar data storage unit 114 of the calendar application 111 as specific data D03.

In the calendar application 111, the calendar data management unit 113 pastes the specific data D03 on a subject field 224 in response to an instruction from the control unit 103, thus displaying the specific data D03 on the display unit 109. While the specific data D01, D02 and D03 are stored at different locations, their data contents are identical. The specific data D02 may be deleted when new data is copied to the clipboard 102.

In FIG. 8, the data selected from email data was pasted in the subject field 224 of the calendar 220. However, the contents of the data should preferably be determined so that the data can be pasted in a predetermined area. For example, based on the result of such determination, date/time data should be pasted in a date field 221 and a time field 222 and location data should be pasted in a location field 223.

Thus, in accordance with the information processing system in the present embodiment, in the email application 101, specific data in the email data contents received by the email reception unit 104 can be easily copied to a new document window in the calendar application 111 in a reduced number of operation steps. By generating calendar data based on the copied data, various items of data, such as the date, time, location and subject, can be displayed in a simpler and faster manner than in the case of newly entering data by using an input device. This can eliminate, in particular, the time-consuming operation necessary for entering new data on such information devices as a PDA.

The user can select not only the contents of the main text data 152 in the email data M01 but also the contents of the email header field 151. Further, when the main text data 152 is not of text format but HTML format, for example, object data such as image and voice may be selected in addition to text data. When file data is attached to an attachment file 153, the data for the attachment file may be selected. In these cases, it is preferable that the application on the receiving end of the specific data is structured or provided with capabilities to relate files in accordance with the specific data. When the application menu is displayed, only those applications having the above capabilities may be selectively displayed.

As the specific data D01 is selected, the application menu 155 of relevant applications that can be selected may be automatically displayed in response to an instruction from the control unit 103. Alternatively, the menu 155 may be displayed through a manual operation, such as tapping a predetermined area or button with a stylus pen. Further alternatively, the menu 155 may be displayed by a manual operation and then the specific data D01 may be selected. The user may be allowed to choose between automatic and manual operations.

The selection operation may be performed not only by dragging the stylus pen 504 but also by operating keys, and therefore the selection operation described in the present embodiment is only exemplary. For example, the email data management unit 106 may read data stored in the email data storage unit 105 in response to an instruction from the control unit 103, or learn the attributes of specific email data that is selected. For example, while the control unit 103 controls the overall operation of the information device, the email data management unit 106 manages data about the email application.

If an area for storing data, such as a buffer memory, corresponding to the data storage unit 107 of the clipboard 102 can be provided, such area may be used in place of the clipboard 102. In this case, the specific data D01 may be copied directly from the email data storage unit 105 of the email application 101 to the calendar data storage unit 114 of the calendar application 111 via the buffer memory, instead of storing it once in the data storage unit 107 of the clipboard 102.

The control unit 103 may also cause the specific data D02 stored in the data storage unit 107 of the clipboard 102 to be pasted in the calendar data storage unit 114 of the calendar application 111 and then displayed in a new document window 220 of the calendar application 111.

The calendar data management unit 113 in the calendar application 111 causes the specific data D01 to be displayed in the subject field 134 in response to an instruction from the control unit 103. The specific data D01 may be displayed not only in the subject field 224 but also in any of the areas referenced by numerals 221 to 223. For example, a pasted-field selection menu may be provided and displayed so that the user can select the field in which the data is to be displayed.

While the information processing system according to the present embodiment related to the case where data in the email application was pasted in the calendar application, this embodiment may be modified variously in the following manner.

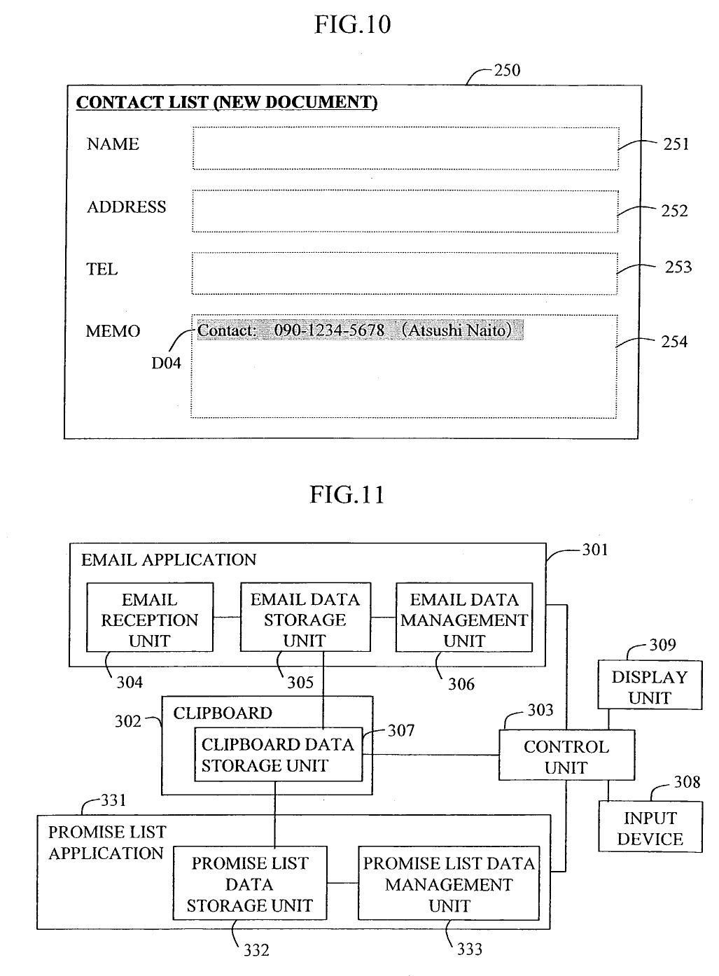

FIGS. 9 and 10 illustrate an example where data in the email application 201 is pasted in the contact list application 221.

Referring to FIG. 9, the operation of the email application 201 and contact list application 221 in a PDA will be described. The PDA includes a control unit 203 for controlling the system as a whole, a clipboard 202, an email reception unit 204 for receiving email, an input device 208 for data entry, and a display unit 209 for displaying data. The clipboard 202 temporarily stores data. The clipboard data storage unit 207 is provided in the clipboard 202 and stores data for each application temporarily.

The email application 201 is further related to an email data storage unit 205 for storing email data and an email data management unit 206 for managing the email data. The contact list application 221 is related to a contact data storage unit 222 for storing contact data and a contact data management unit 223 for managing data for the contact list application 221.

In this embodiment, the specific data D01 selected by the user in the contents of the email data M01 shown in FIG. 6A is substituted with contact data. Thus in this embodiment, the contact data can be easily copied to a new document window 250 in the contact list application 221 as specific data D04 in a reduced number of operation steps, as shown in FIG. 10. By creating an address entry by re-utilizing the copied content, address information such as a name 251, address 252 and telephone number (TEL) 253 can be easily displayed on the PDA.

In the contact list application 221, the contact data management unit 223 causes the specific data D01 to be displayed in a memo pad field 254, however, the display area is not limited to the memo pad field 254. For example, there may be provided a function for determining whether the specific data D01 should be displayed in a name field 251, address field 252, telephone number (TEL) field 253, or memo pad field 254, based on the contents of the specific data D01.

Before displaying the data, the user may be inquired about which specific field he or she wishes to have the data displayed in, by displaying a selection menu, for example.

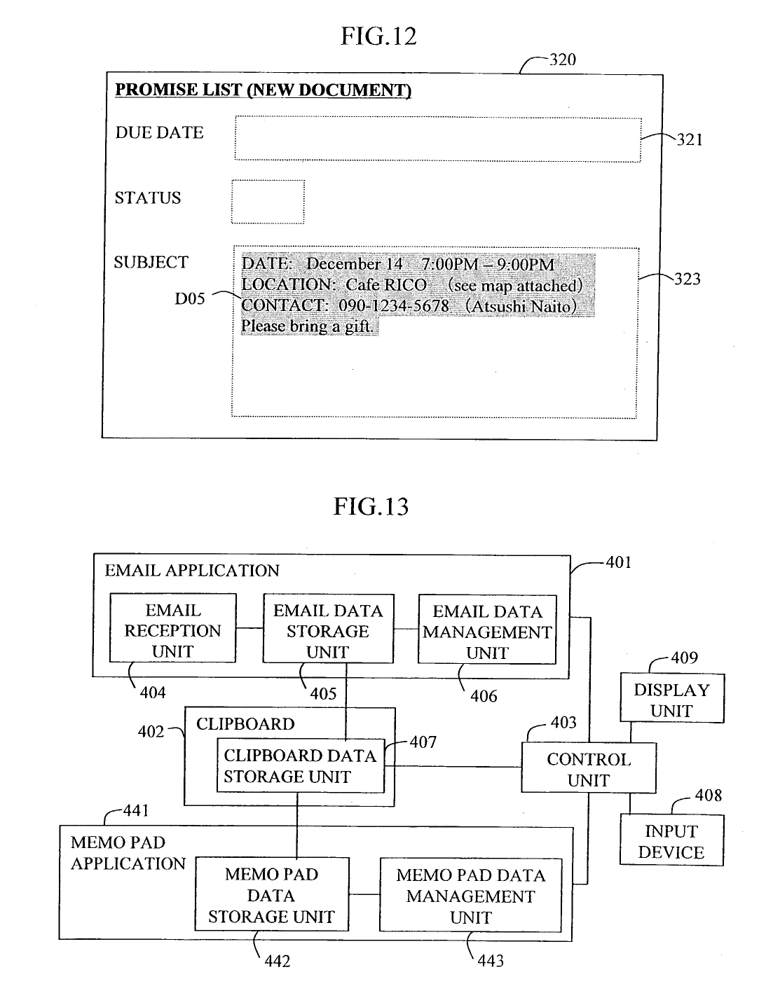

FIGS. 11 and 12 show another embodiment in which the calendar application 221 of FIG. 9 is substituted with a promise-list application 331 and the specific data D01 selected by the user in the contents of the email data M01 is substituted with promise data. In this embodiment, the promise data can be easily copied onto a new document window 320 in the promise-list application 331 as specific data D05 in a reduced number of operation steps. By creating a promise list by re-utilizing the copied contents, promise data such as due date, subject or the like can be easily displayed on a PDA, for example, on which data entry is difficult.

In the promise-list application 331, a promise list data management unit 333 causes the specific data D01 to be displayed in a subject field 323 in response to an instruction from the control unit 303. However, this is only exemplary and the specific data D01 may be displayed in a field other than the subject field 323. Alternatively, before displaying the data, the user may be inquired about which specific field he or she wishes to have the data displayed in, through a display field selection menu.

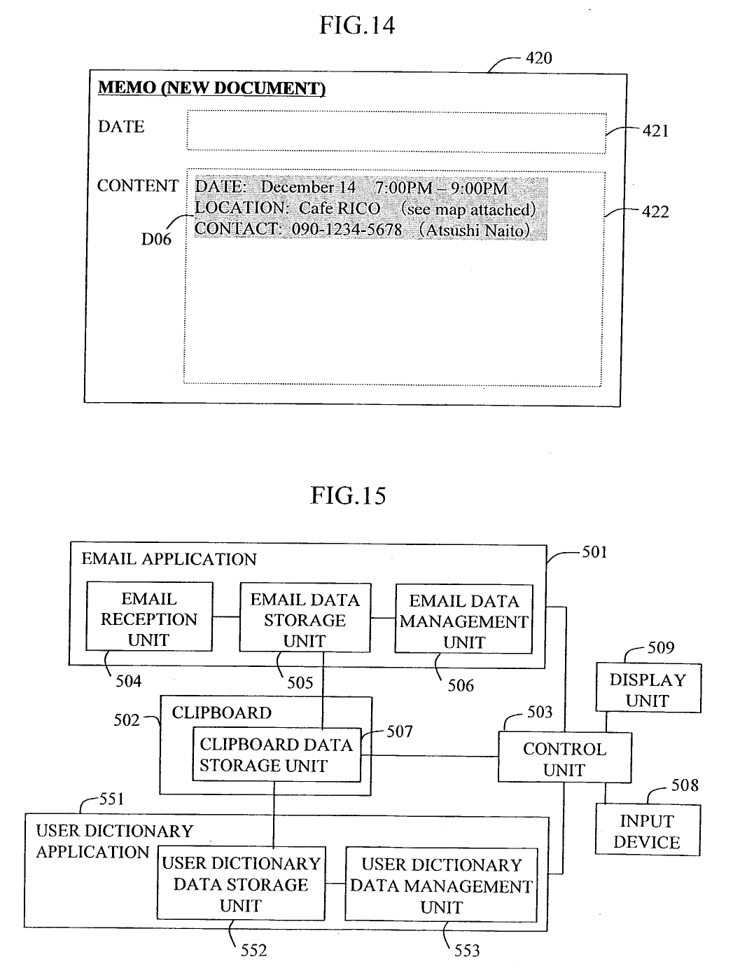

FIGS. 13 and 14 show another embodiment in which the calendar application 111 of FIG. 2 is substituted with a memo pad application 441 and the specific data D01 selected by the user in the email data M01 of FIG. 6B is substituted with memo data. Thus in this example, the memo data can be easily copied as specific data D06 in a content area 422 in a new document window 420 of the memo pad application 441. By creating a memo by re-utilizing the copied contents, the contents of the specific data D01 can be easily entered into the memo pad application 441 in a simple manner (by eliminating the otherwise required operation steps) on a PDA, for example, which is difficult to enter data into. Alternatively, the copied contents may be just registered in the memo pad application 441 without re-utilizing (displaying) them.

In the memo pad application 441, the memo data management unit 443 causes the specific data D01 to be displayed in a content field 422 in response to an instruction from the control unit 403. However, this is only exemplary and so the specific data may be displayed in a date/time field 421 instead of the content field 442. Further, the user may be inquired about which specific field he or she wishes to have the data displayed in, as mentioned above.

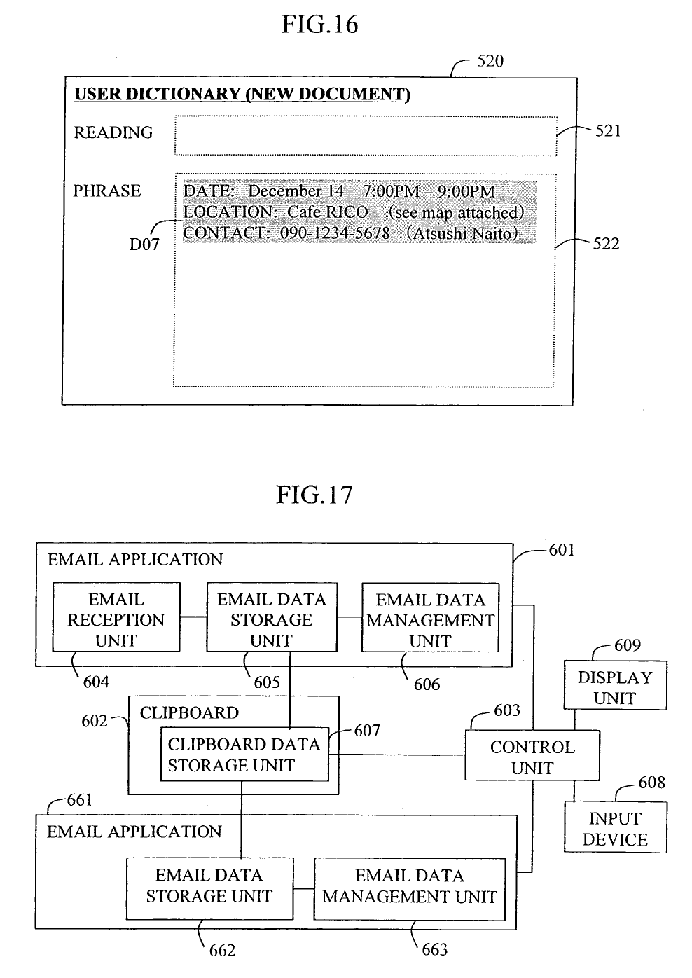

FIGS. 15 and 16 show yet another embodiment in which the calendar application 111 of FIG. 2 is substituted with a user dictionary application 551 and the specific data D01 selected by the user in the contents of the email data M01 is substituted with user dictionary data. Thus in this embodiment, the user dictionary data can be copied as specific data D07 onto a new document window 520 in the user dictionary application 551 easily in a reduced number of operation steps. By creating a user dictionary by re-utilizing the copied contents, data such as a phrase or sentence can be easily entered into a PDA, for example, on which data entry is difficult.

In the user dictionary application 551, a user dictionary data management unit 553 causes the specific data D01 to be displayed in a phrase field 522 in response to an instruction from a control unit 503. However, this is only exemplary and so the display area is not limited to the phrase field 522. For example, the specific data may be pasted in a reading area 521. Further, as mentioned above, before displaying the data, the user may be inquired about which specific field he or she wishes to have the data displayed in.

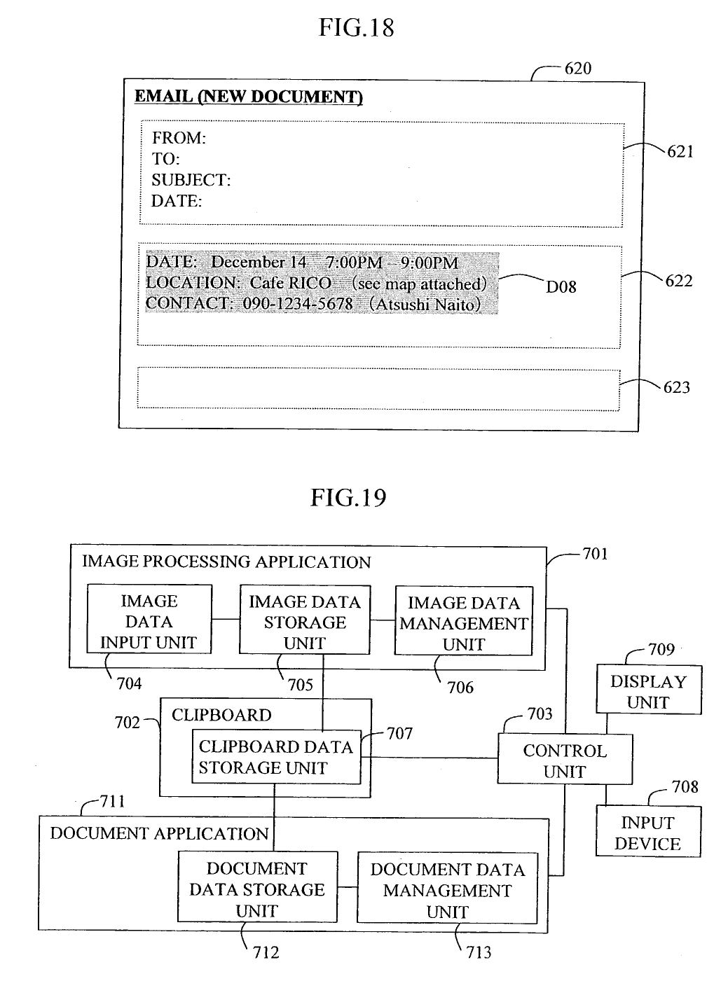

FIGS. 17 and 18 show another embodiment employing email applications 601 and 661 between which data can be exchanged. In this embodiment, the user-selected specific data D01 selected by the user in the contents of the email data M01 is substituted with modified data. Thus in this embodiment, the modified data can be easily copied as specific data D08 onto a new document window 620 of the email application 661 in a reduced number of operation steps. By creating an email by re-utilizing the copied contents, the data can be easily entered into an email header area 621, an email contents area (main text field) 622, or an attachment file area 623 on a PDA, for example, in which data entry is difficult. The email applications 601 and 661 may contain the same contents. Alternatively, they may be identical email applications with different contents.

In the email application 661, an email data management unit 663 causes the specific data D01 to be displayed in an email main text field 622 by the instruction of a control unit 603. However, the field where specific data is displayed is not limited to the email main text field 622. Further, as mentioned above, the user may be inquired about which specific field he or she wishes to have the data displayed in before displaying the data.

It goes without saying that the applications in which the contents of the email data M01 can be processed are not limited to those described in the above embodiments. The specific data D01 as the original data does not always have to be the contents of the email data M01 in the email application 101, and so it may be obtained from data used in another application.

For example, map data downloaded via an Internet application can be selected and pasted in a text file in a document application opened from a selection menu including an email application and the document application. Images taken from a digital camera or figures created in a graphics application can be pasted in a document application. Further, a text in which an image or a figure is pasted can be selected and pasted in an email application.

For example, as shown in FIGS. 19 to 21, an image processing application 701 and a document application 711 may be adapted such that they can exchange data.

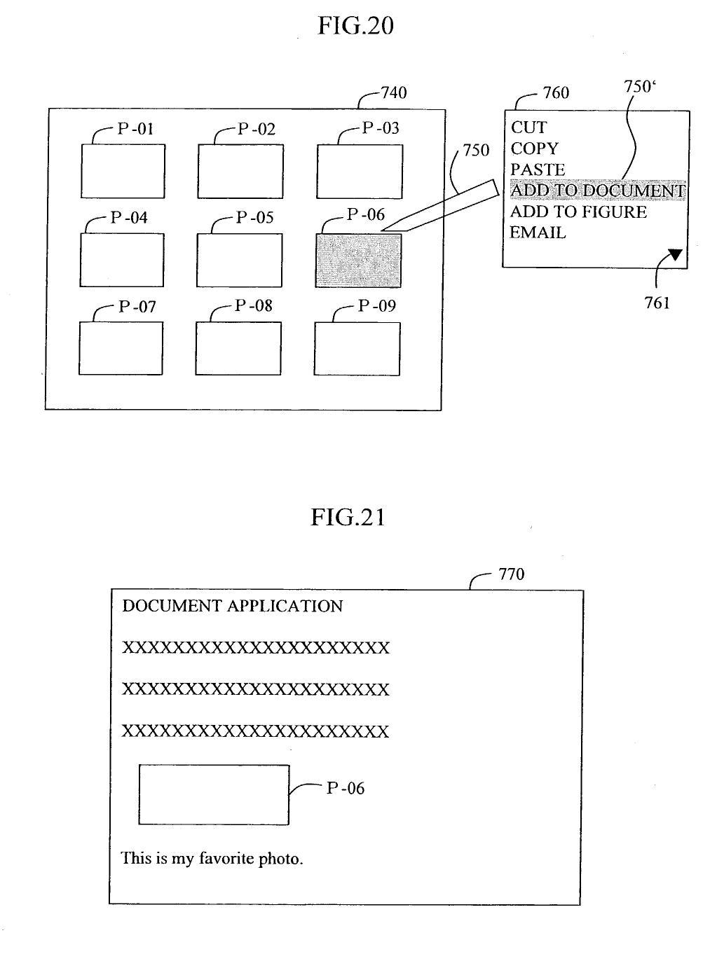

For example, image data captured by a digital camera can be fed into the image processing application 701 via an image data input unit 704. The image data is stored in an image data storage unit 705. For example, image data P01 to P09 shown in FIG. 20 are stored. The image data P01 to P09 are managed by an image data management unit 706.

When a user wishes to use his favorite image P06 in the document application, he drags or points to the image data P06 with a stylus pen 750. In response to the dragging or pointing operation, a relevant application menu 760 is automatically displayed on the display window. When the user selects an “Add to text” option in the relevant application menu 760, the document application 711 opens as shown in FIG. 21, and a new document window 770 of the document application 711 is displayed on the display window of the application. As a text is entered to the new document window 770 by means of an input unit such as the stylus pen 750, a diary entry or a travel essay attached with the favorite photo P06 can be easily created. By creating the text itself with a text received by the email application or a template, for example, the operation can be even more simplified and made more useful.

Conversely, a created diary entry may be selected and the image application 701 can be selected from a selection menu, so that image data attached with a description opens in the image application 701. Based on such data, a photo album, for example, can be created. Alternatively, by selecting part of the data shown in FIG. 21 and opening the email application from the displayed application menu, the above-mentioned specific data can be transmitted in an email as its contents or as an attachment file.

Thus, in the information processing system according to the invention, data entry on a device such as a PDA where data entry can be bothersome can be simplified by re-utilizing the contents of email data from other information devices, for example. In addition, relevant applications can be handled as if they were a single application, thus providing more comfortable sense of operation.

For example, part or all of the contents of a receive email can be easily copied onto a new document window in another application in a reduced number of operation steps. By utilizing the copied contents in creating data, the number of operations necessary for data entry in a device such as a PDA can be reduced.

While the invention has been described with reference to preferred embodiments thereof, it will be understood by those skilled in the art that various modifications, improvements, and combinations can be made within the scope of the invention.

What is claimed is:

1. An information processing system comprising an information device equipped with a display unit and an input unit, the information processing system further comprising:
a control unit for coordinating the operation of a first application running on the information device and that of a second to nth (n=an integer of more than 2) applications that are related to the first application and running on the information device,
wherein the control unit has an application menu display function for displaying, upon selection of specific data in data displayed on the display unit in the first application by means of the input unit, an application menu on the display unit, the application menu showing the name of at least one application selected from the second to nth applications.

2. The information processing system according to claim 1, wherein the application menu is a list of the names of applications that were predicted to be relevant to the specific data based on the contents of the specific data, from which list a desired application can be opened.

3. The information processing system according to claim 1, further comprising a data storage unit for storing the specific data, wherein the control unit has a function for pasting the specific data stored in the data storage unit onto the data displayed on the display unit in the desired application opened from the application menu.

4. The information processing system according to claims 1, further comprising a data reception unit on the first application for receiving external data to be displayed on the display unit.

5. The information processing system according to claims 1, wherein the specific data is attachment data attached to the first application.

6. The information processing system according to claims 1, wherein the control unit automatically causes the application menu to be displayed upon selection of the specific data.

7. The information processing system according to claims 1, wherein the control unit causes the application menu to be displayed when a predetermined operation is performed after the selection of the specific data.

8. An information device comprising a display unit and an input unit, on which a plurality of applications including an email application can be run, the device comprising:
an email reception unit for receiving email from the outside;
an email data storage unit for storing email data received by the email reception unit from the outside; and
a control unit having an application menu display function, an application switching function, and a data paste function,
wherein when specific data in email data that has been stored in the email data storage unit and which is displayed on the display unit is selected by the input unit, the control unit predicts applications relevant to the specific data and displays a list of the names of the predicted applications using the application menu display function, from which list a desired application can be opened,
wherein the desired application can be selected from the application menu and opened by the application switching function, and the specific data can be pasted in a data storage unit of the desired application by the data paste function.

9. The information device according to claim 8, further comprising a clipboard data storage unit for storing the selected specific data, so that the selected specific data can be utilized in a versatile manner.

10. The information device according to claim 8, wherein the first application is selected from the group consisting of an email application, an Internet browser application, a calendar application, an contact list application, an promise-list application, a memo pad application, and a user dictionary application.

11. The information device according to claims 8, wherein the first to nth applications are selected from the group consisting of an email application, an Internet browser application, a calendar application, a contact list application, a promise-list application, a memo pad application, and a user dictionary application.

12. A program for causing an information device to carry out the steps of:
running a first application adapted to run on an information device comprising a display unit and an input unit;
selecting, by means of the input unit, specific data from data displayed on the display unit by the first application; and
displaying, upon selection of the specific data, an application menu showing the name of at least one application selected from a second to nth (n=an integer of more than 2) applications running on the information device.

13. The program according to claim 12, further comprising storing step of the selected specific data in a clipboard data storage unit, so that the selected specific data can be utilized in a versatile manner.

14. The program according to claim 12, wherein the first application is selected from the group consisting of an email application, an Internet browser application, a calendar application, an contact list application, an promise-list application, a memo pad application, and a user dictionary application.

15. The program according to claims 12, wherein the first to nth applications are selected from the group consisting of an email application, an Internet browser application, a calendar application, a contact list application, a promise-list application, a memo pad application, and a user dictionary application.
